(19) United States
(12) Patent Application Publication
(10) Pub. No.: US 2007/0005818 A1
(43) Pub. Date: Jan. 4, 2007

(54) Method and apparatus for managing load on a plurality of processors in network storage system

(75) Inventors: Naoki Tsuruoka, Kawasaki (JP); Osamu Kimura, Kawasaki (JP); Koji Yamaguchi, Kawasaki (JP); Chikashi Maeda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/237,842

(22) Filed: Sep. 29, 2005

(30) Foreign Application Priority Data
Jun. 30, 2005 (JP) 2005-192483

(51) Int. Cl. G06F 3/00

(52) U.S. Cl. 710/5

(57) ABSTRACT

An apparatus for managing a load on a plurality of processors that performs a processing of data received by a plurality of channel adaptors includes a channel-adaptor communicating unit that detects operational statuses of the channel adaptors, and that selects a processor that performs the processing of the data, based on the operational statuses of the channel adaptors.

### BACKGROUND OF THE INVENTION

1. Field of the Invention

The present invention relates to a technology for managing load on a plurality of processors in a network storage system.

2. Description of the Related Art

A network storage system in which data is shared by a plurality of servers on a network is currently in use. In addition, recent network storage system includes a plurality of central processing units (CPUs), and each of the CPUs executes an input/output (I/O) processing with a hard disk device in a parallel manner, to realize a high speed processing.

In such a network storage system, when requests for an I/O processing are received via a plurality of ports from a host computer, the requests are assigned to the CPUs in order, to execute the I/O processing.

However, when a port with a heavy load and a port with a light load are present in a mixed manner, the port with a heavy load places a heavy load on all of the CPUs, which results in a decrease in response and throughput of the I/O processing requested via the port with a light load.

A countermeasure is disclosed in Japanese Patent Application Laid-open No. 2004-171172.

However, in the countermeasure technology, a switching between the CPUs is frequently required, which results in a complicated processing.

In another conventional technology, ports are added or removed according to user's need, so that the number of ports varies. In such a network storage system, as the number of ports is increased, a processing becomes even more complicated.

On the other hand, if the CPUs that execute an I/O processing from each port are predetermined so that loads on the CPUs are well balanced, a switching between the CPUs is not required, and it is possible to prevent the processing from being complicated. However, the addition or removal of the ports can cause an undesirable change of the balance of loads on the CPUs.

Therefore, a development of a technology, in which an efficient CPU load balancing is performed even with a change of the number of ports that receive data from other device such as a host computer, is highly desired.

### SUMMARY OF THE INVENTION

It is an object of the present invention to at least solve the problems in the conventional technology.

An apparatus according to one aspect of the present invention, which is for managing a load on a plurality of processors that performs a processing of data received by a plurality of communicating units, includes a processor selecting unit that detects operational statuses of the communicating units, and that selects a processor that performs the processing of the data, based on the operational statuses of the communicating units.

A method according to another aspect of the present invention, which is for managing a load on a plurality of processors that performs a processing of data received by a plurality of communicating units, includes detecting operational statuses of the communicating units; and selecting a processor that performs the processing of the data, based on the operational statuses of the communicating units.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating a concept of load management processing according to the present invention;

FIG. 2 is a block diagram of a load managing apparatus according to an embodiment of the present invention;

FIG. 3 is a schematic of attachment patterns of channel adaptors (CAs) to four slots;

FIGS. 4A and 4C are schematics for illustrating an example of CPUs for processing an interrupt, determined according to the attachment patterns for the CAs;

FIG. 5 is an example of a CA management table stored in a storing unit;

FIG. 6 is a flowchart of a processing procedure for determining a CPU for processing an interrupt according to the present embodiment; and

FIG. 7 is a flowchart of a procedure for processing an interrupt according to the present embodiment.

### DETAILED DESCRIPTION OF THE PREFERRED EMBODIMENTS

Exemplary embodiments of the present invention will be explained below in detail with reference to the accompanying drawings.

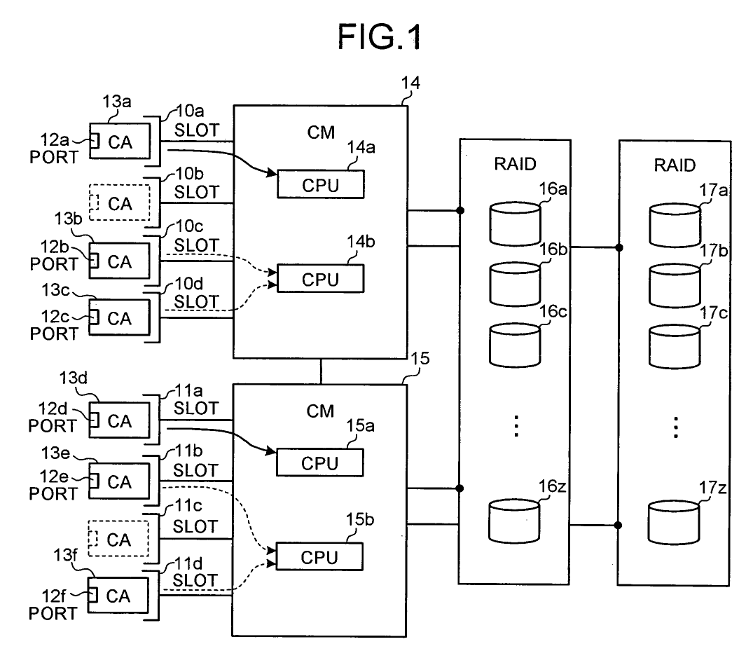

FIG. 1 is a schematic for illustrating a concept of load management processing according to the present invention. The load managing apparatus includes slots 10a to 10d and 11a to 11d to which CAs 13a to 13f are attached, centralized modules (CMs) 14 and 15, and hard disk devices 16a to 16z and 17a to 17z that configure redundant array of independent disks (RAIDs).

The CAs 13a to 13f are peripheral component interconnect (PCI) devices that includes ports 12a to 12f for sending/receiving data to/from a host computer, and control interfaces at the time of sending/receiving the data.

The CAs 13a to 13f are actively added, when the load managing apparatus is switched on or during the operation of the load managing apparatus, at the slots 10a to 10d and 11a to 11d that are installed in advance according to need. The added CAs 13a to 13f are actively removed from the slots 10a to 10d and 11a to 11d.

When a request to input/output data to/from the hard disk devices 16a to 16z and 17a to 17z is received from the host computer, the CAs 13a to 13f make any of CPUs 14a and 14b provided in the CM 14 and CPUs 15a and 15b provided in the CM 15 execute interrupt processing.

The CMs 14 and 15 execute processing for inputting/outputting data to/from the hard disk devices 16a to 16z and 17a to 17z. The CM 14 includes the CPUs 14a and 14b, and the CM 15 includes the CPUs 15a and 15b.

According to the load management processing, at the time of data input/output processing, processing for selecting the CPUs 14a, 14b, 15a, and 15b that process interrupts from the CAs 13a to 13f according to combinations of the CAs 13a to 13f attached to the slots 10a to 10d and 11a to 11d is executed.

For example, as shown in FIG. 1, when the CAs 13a, 13b, and 13c are respectively attached to the slots 10a, 10c, and 10d for the CM 14 (CAs are not attached to the slot 10b), the CPU 14a processes an interrupt from the CA 13a, and the CPU 14b processes interrupts from the CAs 13b and 13c.

When the CAs 13d, 13e and 13f are respectively attached to the slots 11a, 11b, and 11d for the CM 15 (CAs are not attached to the slot 11c), the CPU 15a processes an interrupt from the CA 13d, and the CPU 15b processes interrupts from the CAs 13e and 13f.

By selecting the CPUs 14a, 14b, 15a, and 15b that process interrupt requests according to combinations of the CAs 13a to 13f attached to the slots 10a to 10d and 11a to 11d, even if the number of the CAs 13a to 13f with the ports 12a to 12f is changed, load balancing of the CPUs 14a, 14b, 15a, and 15b are efficiently performed.

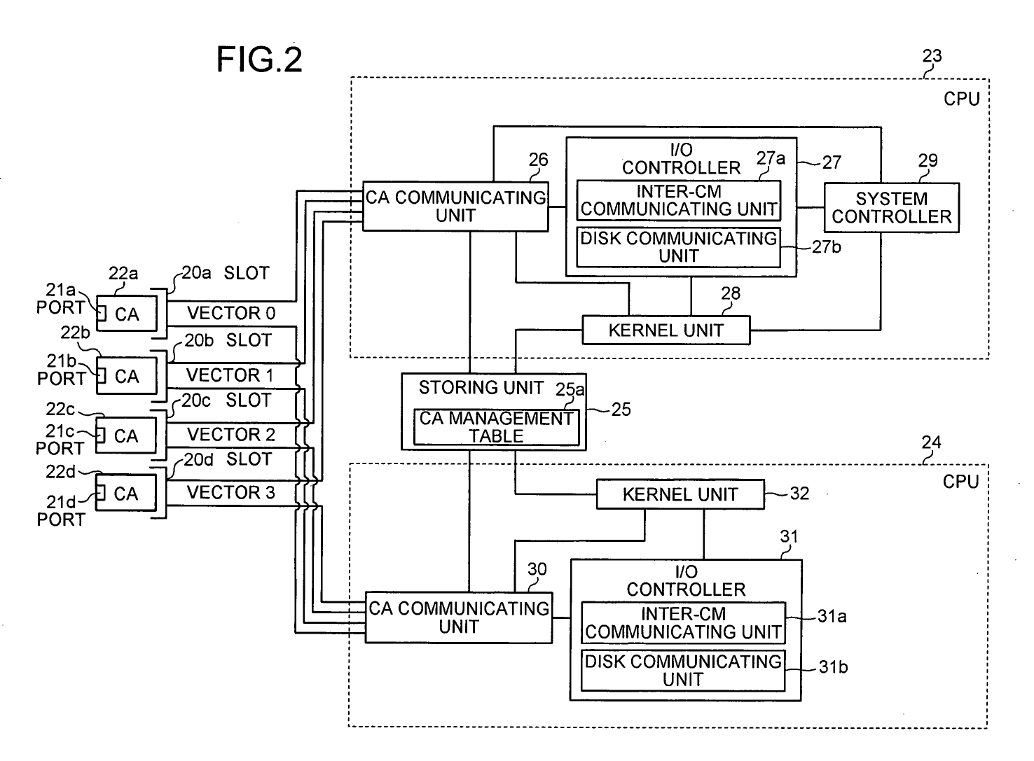

FIG. 2 is a block diagram of a load managing apparatus according to an embodiment of the present invention.

While two CMs 14 and 15 are shown in FIG. 1, a functional configuration of one of them is shown in FIG. 2, because the CMS 14 and 15 have the same function. The hard disk devices 16a to 16z and 17a to 17z are omitted in FIG. 2.

The load managing apparatus has slots 20a to 20d that CAs 22a to 22d with ports 21a to 21d are attached to, a CA communicating unit 26 whose function is implemented by a CPU 23, an I/O controller 27, a kernel unit 28, a system controller 29, a CA communicating unit 30 whose function is implemented by a CPU 24, an I/O controller 31, a kernel unit 32, and a storing unit 25.

The slots 20a to 20d are the same as the slots 10a to 10d and 11a to lid shown in FIG. 1, and the CAs 22a to 22d are the same as the CAs 13a to 13f shown in FIG. 1. The CA communicating unit 26 executes data communication with the CAs 22a to 22d attached to the slots 20a to 20d.

When the CAs 22a to 22d are actively added at or removed from the slots 20a to 20d, the CA communicating unit 26 detects such addition or removal, determines CPUs 23 and 24 that process interrupts from the CAs 22a to 22d attached to the slots 20a to 20d, and stores information of such processing in the storing unit 25.

Specifically, the CA communicating unit 26 determines the CPUs 23 and 24 that process interrupt processing requested from the CAs 22a to 22d according to combinations of the CAs 22a to 22d attached to the slots 20a to 20d.

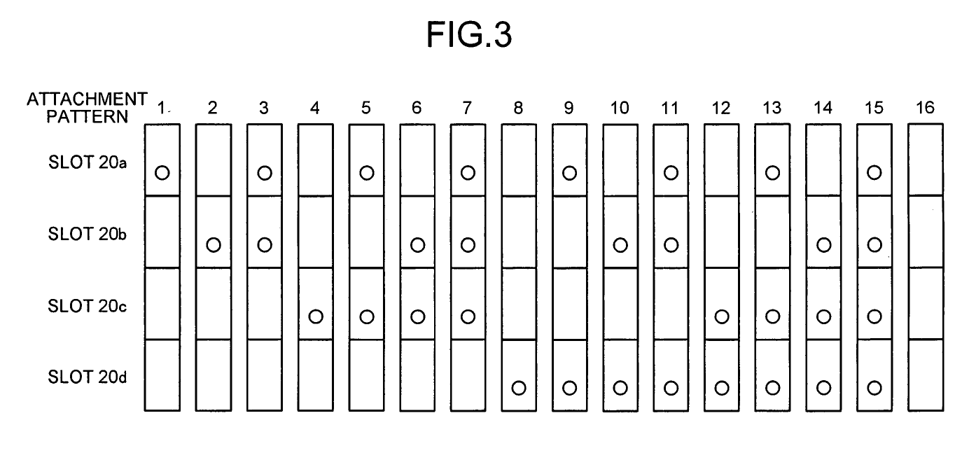

FIG. 3 is a schematic of attachment patterns of the CAs 22a to 22d to four slots 20a to 20d. The circle marks indicate slots to which the CAs 22a to 22d are attached. As shown in FIG. 3, sixteen attachment patterns are provided when there are four slots, i.e., the slots 20a to 20d.

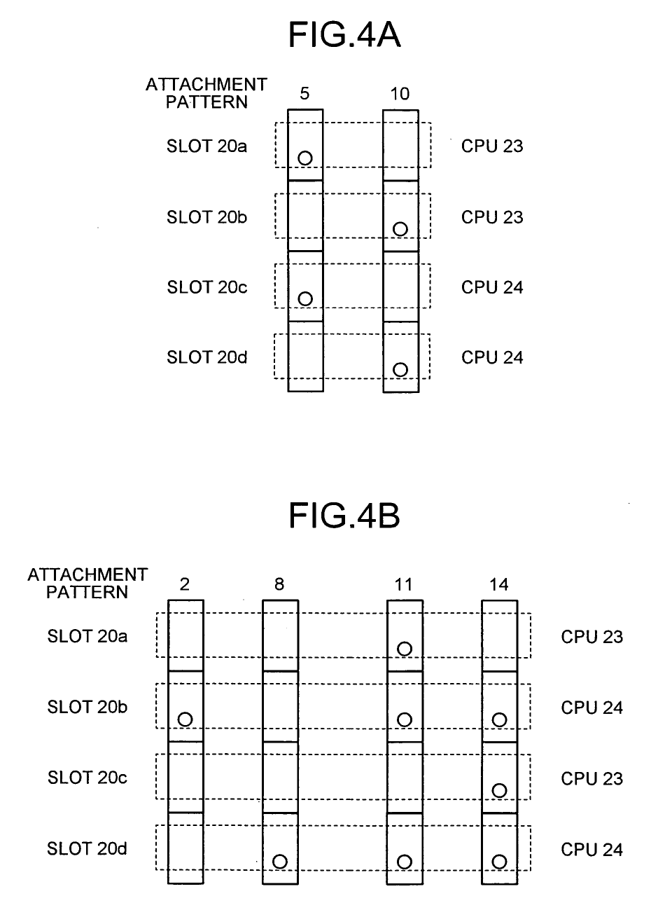

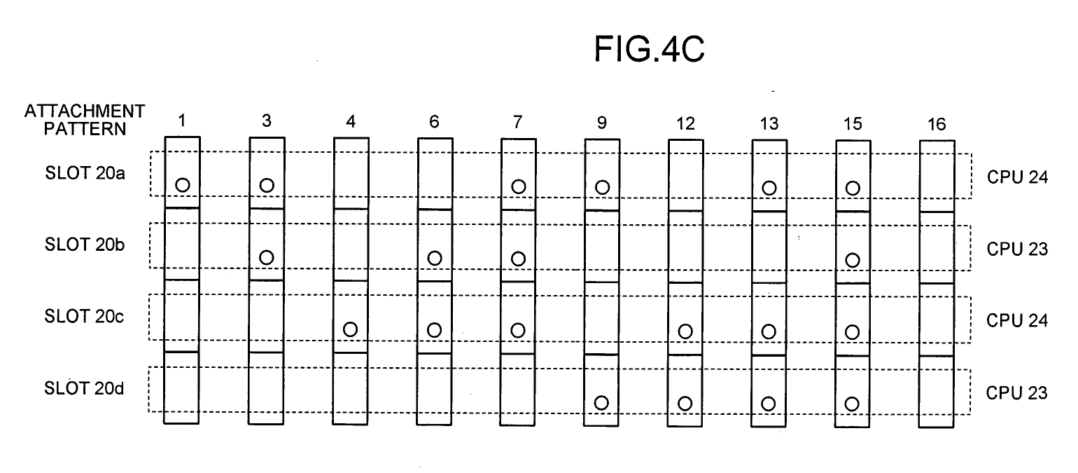

FIGS. 4A and 4C are schematics for illustrating an example of the CPUs 23, 24 for processing an interrupt, determined according to the attachment patterns for the CAs 22a to 22d.

According to the present embodiment, when the attachment patterns shown in FIG. 3 are 5 or 10, the CPU 23 is assigned to interrupts from the CA 22a and the CA 22b, which are attached to the slot 20a and the slot 20b, respectively. The CPU 24 is assigned to interrupts from the CA 22c and the CA 22d, which are attached to the slot 20c and the slot 20d, respectively.

As shown in FIG. 4B, when the attachment patterns shown in FIG. 3 are 2, 8, 11, or 14, the CPU 23 is assigned to interrupts from the CA 22a and the CA 22c, which are attached to the slot 20a and the slot 20c, respectively. The CPU 24 is assigned to interrupts from the CA 22b and the CA 22d, which are attached to the slot 20b and the slot 20d, respectively.

As shown in FIG. 4C, when the attachment patterns shown in FIG. 3 are other than the above patterns, the CPU 23 is assigned to interrupts from the CA 22b and the CA 22d, which are attached to the slot 20b and the slot 20d, respectively. The CPU 24 is assigned to interrupts from the CA 22a and the CA 22c, which are attached to the slot 20a and the slot 20c, respectively.

As explained later, a load of the CPU 23 can be heavier than that of the CPU 24, because the system controller 29 in the CPU 23 controls the load managing apparatus. For this reason, as shown in FIGS. 4B and 4C, settings are configured so that the number of the CAs 22a to 22d processed by the CPU 24 is equal to or larger than that processed by the CPU 23 in the respective attachment patterns.

Assignments for the CPUs 23 and 24 shown in FIGS. 4A to 4C can be implemented by the CA communicating unit 26 executing a wired logic. Alternatively, information of the CPUs 23 and 24 that process interrupts from the CAs 22a to 22d can be stored in advance in the storing unit 25 so as to correspond to combinations of the CAs 22a to 22d attached to the slots 20a to 20d. The CA communicating unit 26 then executes assignment by referring to the information.

Furthermore, when it is determined that the CPU 23 processes interrupts from some of the CAs 22a to 22d, the CA communicating unit 26 creates a CA management table 25a in which interrupt vectors uniquely assigned to the respective CAs 22a to 22d are made to correspond to interrupt handlers and stores the created table in the storing unit 25.

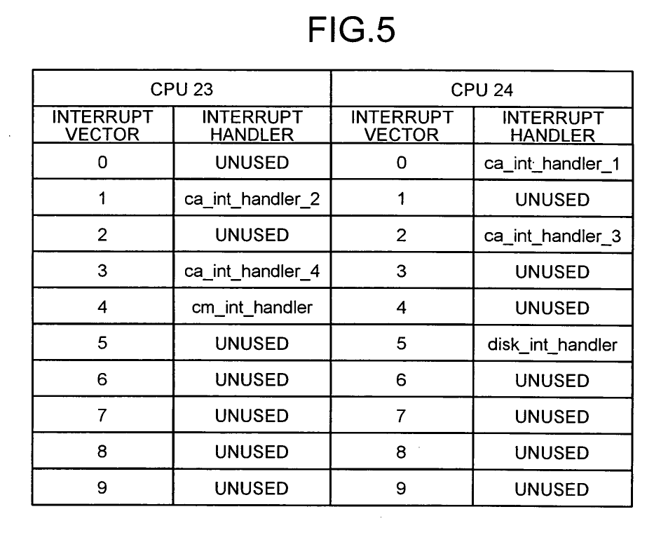

FIG. 5 is an example of the CA management table 25a stored in the storing unit 25. FIG. 5 is an example when the attachment pattern shown in FIG. 3 is 15, i.e., a case that four CAs 22a to 22d are attached to the slots 20a to 20d.

As shown in FIG. 5, interrupt vectors and interrupt handlers that are made to correspond to the respective CPUs 23 and 24 are stored in the CA management table 25a.

An interrupt handler “ca_int_handler_{—}1” corresponds to the CA 22a, an interrupt handler “ca_int_handler_{—}2” corresponds to the CA 22b, an interrupt handler “ca_int_handler_{—}3” corresponds to the CA 22c, and an interrupt handler “ca_int_handler_{—}4” corresponds to the CA 22d.

According to the example shown in FIG. 5, interrupt handlers for the CPU 24 are stored in the interrupt vectors “0” and “2”, and interrupt handlers for the CPU 23 are stored in the interrupt vectors “1” and “3”. Settings are configured such that interrupts from the CAs 22b and 22d are processed by the CPU 23, and interrupts from the CAs 22a and 22c are processed by the CPU 24.

The CA communicating unit 26 refers to the CA management table 25a and registers interrupt vectors and interrupt handlers to be processed by the CPU 23 in the kernel unit 28 so as to correspond to the CAs 22a to 22d that generate interrupts.

The I/O controller 27 controls data input/output to/from other CMs or hard disk devices. The I/O controller 27 has an inter-CM communicating unit 27a and a disk communicating unit 27b.

The inter-CM communicating unit 27a sends/receives control data to/from other CMs. The disk communicating unit 27b executes processing for transferring data requested by a host computer connected to the CAs 22a to 22d to be stored to hard disk devices and for retrieving data requested by the host computer to be retrieved from hard disk devices.

The kernel unit 28 receives requests to register interrupt vectors and interrupt handlers processed by the CPU 23 from the CA communicating unit 26 and registers received interrupt vectors and interrupt handlers so as to correspond to the CAs 22a to 22d that generate interrupts.

When an interrupt from any of the CAs 22a to 22d is generated and the CPU 23 processes that interrupt, the kernel unit 28 executes the interrupt handler.

The system controller 29 controls the power of the load managing apparatus and monitor systems.

The CA communicating unit 30 executes data communication with the CAs 22a to 22d attached to the slots 20a to 20d.

The CA communicating unit 30 refers to the CA management table 25a and registers interrupt vectors and interrupt handlers to be processed by the CPU 24 in the kernel unit 32 so as to correspond to the CAs 22a to 22d that generate interrupts.

The I/O controller 31 controls, as the I/O controller 27, data input/output to/from other CMs or hard disk devices. The I/O controller 31 has a CM communicating unit 31a and a disk communicating unit 31b.

The CM communicating unit 31a sends/receives control data to/from other CMs. The disk communicating unit 31b executes processing for transferring data requested by a host computer connected to the CAs 22a to 22d to be stored to hard disk devices and for retrieving data requested by the host computer to be retrieved from hard disk devices.

The kernel unit 32 receives requests for registering interrupt vectors and interrupt handlers processed by the CPU 24 from the CA communicating unit 30 and registers received interrupt vectors and interrupt handlers so as to correspond to the CAs 22a to 22d that generate interrupts.

When an interrupt from any of the CAs 22a to 22d is generated and the CPU 24 processes that interrupt, the kernel unit 32 executes the interrupt handler.

The storing unit 25 is a storage device such as a memory and stores various data retrieved from the CPUs 23 and 24. Specifically, the storing unit 25 stores information such as the CA management table 25a shown in FIG. 5.

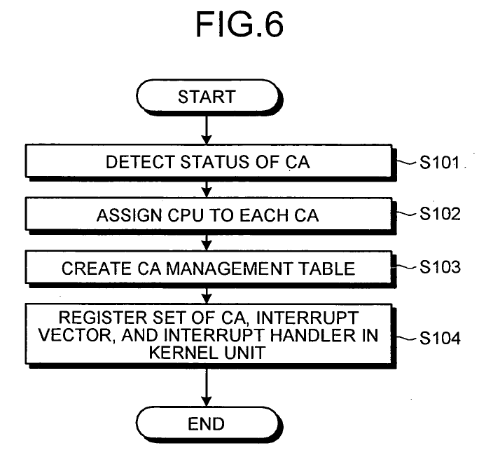

FIG. 6 is a flowchart of a processing procedure for determining a CPU for processing an interrupt according to the present embodiment.

When the CAs 22a to 22d are added or removed, the CA communicating unit 26 of the load managing apparatus firstly detects the CAs 22a to 22d attached to the slots 20a to 20d (step S101).

The CA communicating unit 26 assigns, as shown in FIGS. 4A to 4C, the CPUs 23 and 24 that process interrupts from the CAs 22a to 22d to the respective CAs 22a to 22d according to attachment patterns 1 to 16 for the CAs 22a to 22d (step S102).

The CA communicating unit 26 subsequently creates the CA management table 25a shown in FIG. 5 in which interrupt vectors corresponding to the CAs 22a to 22d are made to correspond to interrupt handlers (step S103).

The CA communicating units 26 and 30 register sets of interrupt vectors and interrupt handlers processed by the CPUs 23 and 24 and the CAs 22a to 22d that generate interrupts in the kernel units 28 and 32 (step S104). In this way, the processing for determining the CPU that processes an interrupt ends.

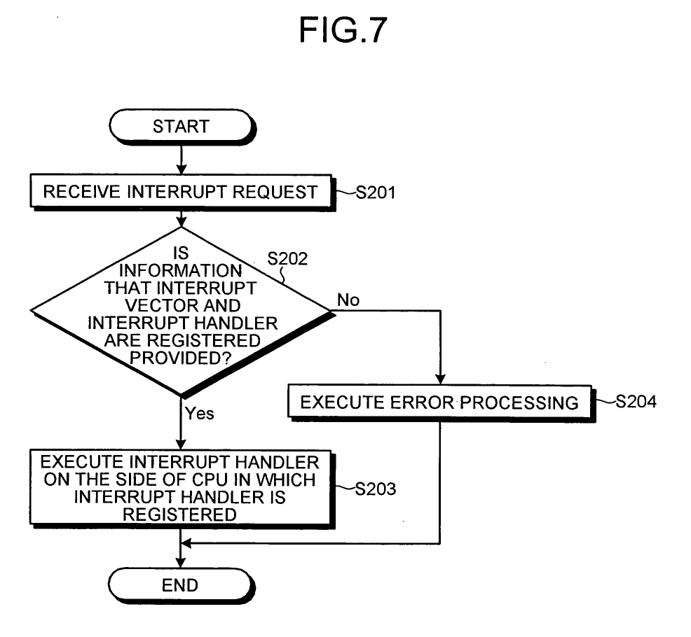

FIG. 7 is a flowchart of a procedure for processing an interrupt according to the present embodiment.

When an interrupt request is generated by, for example, data sent from the CAs 22a to 22d, the kernel units 28 and 32 in the load managing apparatus receive the interrupt request (step S201).

The kernel units 28 and 32 then check whether an interrupt vector for the corresponding interrupt and an interrupt handler corresponding to the interrupt vector are registered (step S202).

If the interrupt vector and the interrupt handler corresponding the interrupt vector are registered either of the kernel units 28 and 32 (step S202, Yes), either of the kernel units 28 and 32 that registers the interrupt handler on the side of either of the CPUs 23 and 24 with the corresponding kernel unit executes the interrupt handler (step S203), and the interrupt processing ends.

If the interrupt vector for the corresponding interrupt and the interrupt handler corresponding to the interrupt vector are not registered in the kernel units 28 and 32 (step S202, No), the kernel units 28 and 32 execute error processing such as output of error signals (step S204), and the interrupt processing ends.

As explained above, according to the present embodiment, the CA communicating unit 26 detects operational status of a plurality of the CAs 22a to 22d with the ports 21a to 21d and selects the CPUs 23 and 24 that process data received by the CAs 22a to 22d according to the detected operational status. Thus, even if the number of the CAs 22a to 22d is changed, load balancing for the CPUs 23 and 24 is efficiently performed.

According to the present embodiment, even if the number of the CAs 22a to 22d is changed by any of the CAs 22a to 22d being detached, load balancing for the CPUs 23 and 24 is efficiently performed.

Furthermore, according to the present embodiment, the CA communicating unit 26 detects combinations of the slots 20a to 20d with the CAs 22a to 22d being attached thereto and selects the CPUs 23 and 24 that process data received by the respective CAs 22a to 22d based on information concerning detected combinations of the slots 20a to 20d. By selecting the CPUs 23 and 24 according to combinations of the slots 20a to 20d with the CAs 22a to 22d being attached thereto, the CPUs 23 and 24 are selected so that load management is appropriately performed.

Moreover, according to the present embodiment, load balancing for the CPUs 23 and 24 is appropriately performed.

Furthermore, according to the present embodiment, when the CPUs 23 and 24 are requested to execute the interrupt processing, load balancing for the CPUs 23 and 24 is efficiently performed.

Although an embodiment of the present invention is explained above, variously modified embodiments other than the explained one can be also made without departing from the scope of the technical spirit of the appended claims.

According to the present embodiment, if any of the CAs 22a to 22d is attached or removed, such attachment or removal is detected and the CPUs 23 and 24 that process interrupts from the respective CAs 22a to 22d are determined according to attachment patterns for the CAs 22a to 22d. Alternatively, when the CAs 22a to 22d are attached to the load managing apparatus in a fixed manner, it is detected whether the CAs 22a to 22d are operated or stopped. Based on combinations of operating CAs 22a to 22d, the CPUs 23 and 24 that process interrupts can be determined.

Among the respective processing explained in the present embodiment, all or a part of the processing explained as being performed automatically can be performed manually, or all or a part of the processing explained as being performed manually can be performed automatically in a known method.

The information including the processing procedure, the control procedure, specific names, and various kinds of data and parameters shown in this specification or in the drawings can be optionally changed, unless otherwise specified.

The respective constituents of the load managing apparatus are functionally conceptual, and the physically same configuration is not always necessary. In other words, the specific mode of dispersion and integration of the load managing apparatus is not limited to the depicted ones, and all or a part thereof can be functionally or physically dispersed or integrated in an optional unit, according to the various kinds of load and the status of use.

All or an optional part of the various processing functions performed by the load managing apparatus can be realized by the CPU or a program analyzed and executed by the CPU, or can be realized as hardware by the wired logic.

Moreover, according to the present invention, even when the number of the communicating units that receive data is changed, load balancing for the processors can be efficiently performed.

Furthermore, according to the present invention, even when the number of the communicating units is changed by the communicating units being detached, load balancing for the processors can be efficiently performed.

Moreover, according to the present invention, by selecting the processors according to combinations of the slots to which the communicating units are attached, the processors are selected so that load balancing is appropriately performed.

Furthermore, according to the present invention, load balancing for the processors can be appropriately performed.

Moreover, according to the present invention, when the processors are requested to execute the interrupt processing, load balancing for the processors can be efficiently performed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for managing a load on a plurality of processors that performs a processing of data received by a plurality of communicating units, the apparatus comprising:
a processor selecting unit that detects operational statuses of the communicating units, and selects a processor that performs the processing of the data, based on the operational statuses of the communicating units.

2. The apparatus according to claim 1, wherein when the communicating units are detachable with respect to slots of a local apparatus, the processor selecting unit detects the operational statuses of the communicating units by determining whether the communicating units are attached to the slots.

3. The apparatus according to claim 2, wherein the processor selecting unit detects a combination of the slots to which the communicating units are attached, and selects the processor based on the combination of the slots.

4. The apparatus according to claim 2, wherein
the processors include a first processor and a second processor, and
when the first processor performs a processing of first data and the second processor performs a control of the local apparatus in addition to a processing of second data, the processor selecting unit selects the processor in such a manner that number of slots to which communicating units that receive the first data are attached is equal to or larger than number of slots to which communicating units that receive the second data are attached.

5. The apparatus according to claim 1, wherein the processing of data is an interrupt processing.

6. A method of managing a load on a plurality of processors that performs a processing of data received by a plurality of communicating units, the method comprising:
detecting operational statuses of the communicating units; and
selecting a processor that performs the processing of the data, based on the operational statuses of the communicating units.

7. The method according to claim 6, wherein when the communicating units are detachable with respect to slots of a local apparatus, the detecting includes detecting the operational statuses of the communicating units by determining whether the communicating units are attached to the slots.

8. The method according to claim 7, wherein
the detecting includes detecting a combination of the slots to which the communicating units are attached, and
the selecting includes selecting the processor based the combination of the slots.

9. The method according to claim 7, wherein
the processors include a first processor and a second processor, and
when the first processor performs a processing of first data and the second processor performs a control of the local apparatus in addition to a processing of second data, the selecting includes selecting the processor in such a manner that number of slots to which communicating units that receive the first data are attached is equal to or larger than number of slots to which communicating units that receive the second data are attached.

10. The method according to claim 6, wherein the processing of data is an interrupt processing.
